(19) United States
(12) Patent Application Publication
(10) Pub. No.: US 2026/0046634 A1
(43) Pub. Date: Feb. 12, 2026

(54) GAME FRAMEWORK FOR DYNAMIC SPECTRUM ALLOCATION

(71) Applicant: Cisco Technology, Inc., San Jose, CA (US)

(72) Inventors: Peiman Amini, Fremont, CA (US); John Matthew Swartz, Lithia, FL (US); Ardalan Alizadeh, Milpitas, CA (US); Robert Edgar Barton, Richmond (CA); Matthias Falkner, Ottawa (CA)

(21) Appl. No.: 18/798,335

(22) Filed: Aug. 8, 2024

(51) Int. Cl. H04W 16/14; H04W 72/0453; H04W 72/542

(52) U.S. Cl. CPC H04W 16/14; H04W 72/0453; H04W 72/542

(57) ABSTRACT

Techniques described herein can apply a game framework for dynamic spectrum allocation. A local spectrum management controller (SMC) associated with a geographic area can receive multiple spectrum requests from multiple network controllers in the geographic area. The SMC can allocate spectrum resources among the multiple network controllers by assigning a respective value to each respective spectrum request, wherein the respective value is adjusted based on a respective historic spectrum use efficiency of a respective network controller. The multiple spectrum requests can then be processed according to a spectrum allocation game which uses respective values to determine multiple spectrum allocations to the multiple network controllers.

### TECHNICAL FIELD

The present disclosure relates generally to spectrum allocation for wireless networks, and to spectrum allocation among transmitters in a same geographic area in particular.

### BACKGROUND

Current static spectrum allocation methods fall short in addressing the variable and often competing demands placed on the 6 GHz band. These traditional methods lack the flexibility to adapt to real-time changes in network usage, leading to suboptimal spectrum utilization, increased interference, and unfair spectrum access.

Some spectrum management systems, such as automated frequency coordination (AFC), and similar proposed systems in Europe, are designed to manage spectrum dynamically. While these efforts therefore represent an improvement, they have so far not adequately encouraged efficient spectrum use. There is a need for the development of solutions that encourage efficient, equitable, and dynamic management of the spectrum.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture comprising a remote spectrum management controller (SMC), a local SMC, network controllers, and user equipment (UEs), wherein spectrum used by the network controllers to communicate with the UEs is allocated by the local SMC in cooperation with the remote SMC, in accordance with various aspects of the technologies disclosed herein.

FIG. 2 illustrates an example local SMC and example components thereof, in accordance with various aspects of the technologies disclosed herein.

FIG. 3 illustrates an example network controller comprising an agent adapted to interact with a local SMC, in accordance with various aspects of the technologies disclosed herein.

FIG. 4 illustrates an example packet switching system that can be utilized to implement devices in accordance with various aspects of the technologies disclosed herein.

FIG. 5 illustrates an example node that can be utilized to implement devices in accordance with various aspects of the technologies disclosed herein.

FIG. 6 illustrates an example computer hardware architecture that can implement devices in accordance with various aspects of the technologies disclosed herein.

FIG. 7 is a flow diagram that illustrates an example method for a local SMC to allocate spectrum based at least in part on a spectrum allocation game, in accordance with various aspects of the technologies disclosed herein.

### DESCRIPTION OF EXAMPLE EMBODIMENTS

### Overview

This disclosure describes techniques that can be performed in connection with a game framework for dynamic spectrum allocation. Example techniques can include receiving, at a local spectrum management controller associated with a geographic area, multiple spectrum requests from multiple network controllers adapted to transmit and receive wireless signals in the geographic area. The multiple network controllers can include at least one wireless fidelity (Wi-Fi) local area network (LAN) controller, and at least one cellular access network controller, and the multiple spectrum requests can be received via an application programming interface (API) at the local spectrum management controller.

Example techniques can further include allocating, by the local spectrum management controller, spectrum resources among the multiple network controllers. Allocating the spectrum resources can comprise, e.g., assigning a respective value to each respective spectrum request, wherein the respective value is adjusted based on a respective historic spectrum use efficiency of a respective network controller. The multiple spectrum requests can then be processed according to a spectrum allocation game which uses respective values assigned to the multiple spectrum requests to determine multiple spectrum allocations to the multiple network controllers.

A combined spectrum use efficiency can be increased or optimized as a result of applying the spectrum allocation game. For example, the multiple spectrum allocations can comprise a first combined spectrum use efficiency which is higher than at least one second combined spectrum use efficiency resulting from different spectrum allocations to the multiple network controllers.

The techniques described herein may be performed by one or more computing devices comprising one or more processors and one or more computer-readable media storing computer-executable instructions that, when executed by the one or more processors, cause the one or more processors to perform the methods disclosed herein. The techniques described herein may also be accomplished using non-transitory computer-readable media storing computer-executable instructions that, when executed by one or more processors, perform the methods carried out by the network controller device.

### EXAMPLE EMBODIMENTS

In an example according to this disclosure, a game framework can be applied in connection with dynamic spectrum allocation. The disclosed spectrum management methods can be deployed via on-premises and/or or cloud-based controllers. Methods can be designed to dynamically coordinate spectrum allocation between cellular and Wi-Fi networks in the 6 GHz band. Examples can leverage the strategic decision-making framework of game theory to facilitate real-time, regulation-compliant spectrum allocation and inter-network coordination, enhancing spectrum efficiency while preventing harmful interference.

A spectrum management controller (SMC) is disclosed to perform the spectrum allocation techniques described herein. The SMC can be implemented according to a cohesive and scalable architecture and can be designed to operate seamlessly across cloud-based and on-premises environments. This dual-mode operation ensures that the disclosed SMC can execute complex game-theoretic algorithms, manage spectrum bids effectively, and deliver real-time decision-making to adapt to both immediate and predictive network requirements.

A cloud-based SMC component, also referred to herein as a remote SMC, can comprise the strategic brain of spectrum management operations, capable of processing large-scale data analytics to make informed decisions over expansive geographical regions. The cloud-based SMC component can be designed to process long-term trends and coordinate complex, multi-operator spectrum allocation scenarios.

An on-premises SMC component, also referred to herein as a local SMC, can be engineered for agility. The on-premises SMC can provide a localized control mechanism allowing for swift response to real-time network conditions and enabling a direct interface with both wireless LAN controllers and cellular network equipment.

An example system architecture can further include a standardized API, integral to the operation of both cloud-based and on-premises SMCs. The API can allow for seamless communication and coordination with wireless LAN controllers and cellular network equipment. This API can support submission of spectrum bids with enhanced contextual awareness, real-time reporting of network conditions, capturing a detailed picture of network congestion and signal quality, and reception of dynamic spectrum allocation decisions, informed by a sophisticated optimization engine that synthesizes game-theoretic principles, real-time data analytics, and machine learning.

An optimization engine at the core of the SMC can be augmented with context-aware processing modules and decision trees, enabling a nuanced approach to managing a sequential multi-round bidding process. The optimization engine can determine a more efficient or a most efficient spectrum allocation for each round, incorporating not just current demands but also predictive behavioral models and roaming analytics, especially relevant in complex environments like stadiums.

In some examples, real-time data collection on network usage and congestion levels can be refined to influence game rule adaptations dynamically, ensuring the SMC's decisions reflect both the present and anticipated network landscapes.

Furthermore, an enhanced reputation and incentive mechanism can be included to track network operators' historical and present cooperative behaviors, utilizing this data to assign access rights and prioritize future spectrum allocations. This system can be enriched with a feedback loop that fosters an environment of continuous improvement among networks.

To ensure network reliability, the SMC can also govern a strategic reserve pool of spectrum, which can be accessible through a rapid response bidding process, designed to address emergency demands and unexpected surges in network traffic.

The SMC can allocate spectrum at least in part according to outcomes of a dynamic spectrum allocation game. In the dynamic spectrum allocation game, cellular and Wi-Fi networks act as players competing for spectrum resources. The game can be designed with mechanisms to encourage cooperation and ensure that each player's actions lead to overall optimal spectrum utilization. For instance, during peak usage times, a Wi-Fi network may ‘bid’ for additional spectrum from the cellular band, offering in exchange a future ‘spectrum credit’ when demand shifts. This method ensures flexible and efficient use of the spectrum, catering to real-time network demands.

In one aspect of the dynamic spectrum allocation game, a multi-round bidding process can be used for spectrum allocation. Networks can submit bids in sequential rounds. After each round, partial allocations can be made based on the current bids, and networks can adjust their bids in subsequent rounds based on remaining availability and competitors' actions. This approach allows for more granular control and adaptive strategy development over the spectrum allocation process. Within this framework, context-aware procedures can dynamically adapt strategies to real-time data and predictive analytics, ensuring that each round of bidding anticipates and responds to fluctuating network needs and historical trends.

In some examples, decision tree learning can be used to evaluate current network conditions against a set of historical and predictive indicators. It assesses factors such as event schedules, user density predictions, and roaming patterns to guide spectrum bidding. For example, when an event at a stadium is approaching, example methods can predict the increase in demand by considering the size and nature of the event, historical data on network usage during similar events, and weather patterns that may affect attendance.

Consider a high-profile football game at a stadium, with a crowd of 70,000 expected. The SMC can be configured to analyze data from previous games, considering factors such as attendance, peak usage times, and network performance. If historically the cellular network becomes congested 30 minutes before the game and during halftime, the algorithm may allocate more spectrum to the cellular network during these periods. The decision tree can evaluate these historical factors and current real-time data, such as early arrivals tracked through ticket scans and social media check-ins, to dynamically adjust spectrum bids before and during the game.

In another aspect, patterns of user movement and roaming behavior can be analyzed to predict when and where network loads will increase, suggesting real-time allocation adjustments. In the context of open roaming, this method can guide the system to distribute users across available networks optimally. The best network can be determined for a user by considering the user's location, the current load and performance metrics of the nearby networks, and historical roaming success rates. This ensures a smooth roaming experience and alleviates congestion by preventing an overload on any single network.

For instance, consider a scenario in which a technology conference is taking place near a stadium, drawing a significant number of tech-savvy attendees who frequently use their devices for high-bandwidth activities. Example methods can assess data from past conferences, including movement patterns between conference halls and common times for network switching. By anticipating areas of high demand and times when attendees typically roam between networks, an SMC can be configured to preemptively direct roaming clients to a most suitable network. For example, if attendees typically switch from Wi-Fi to cellular during lunch breaks outside the venue, the system can balance the load by allocating more spectrum to cellular networks in anticipation of this behavior.

Conditional access rights can also be implemented based on network behavior and historical cooperation levels. Networks that consistently cooperate and efficiently use spectrum can earn priority access or discounts in future bidding rounds, promoting positive spectrum sharing behaviors and penalizing wasteful or aggressive strategies. Further enhancing this model, learning-enhanced game mechanisms can leverage past interaction data to refine future access right conditions, applying reinforcement learning to cultivate an increasingly cooperative and efficient spectrum environment.

Some implementations can include reward-based incentivization, in which networks demonstrating efficient spectrum usage during non-peak hours can be granted first preference during high-demand events or can receive discounts on their spectrum bids. This reward system can be continuously refined by analyzing a variety of metrics such as throughput, user engagement, and quality of service (QoS) adherence.

Conversely, networks that exhibit aggressive bidding or poor spectrum management may face penalties for non-cooperative behavior, such as increased bid prices or delayed access to spectrum resources. These deterrents are not static; they are dynamically calibrated based on an ongoing assessment of network behaviors, ensuring that penalties are fair and proportionate to the behavior observed.

Some implementations can include a collaborative protocol in which networks share interference mitigation strategies, such as dynamic beamforming techniques and power adjustment strategies. By sharing successful strategies, networks can collectively improve the overall spectrum environment, reducing interference and enhancing efficiency. This includes a system for predictive interference mapping, where analytics are used to forecast and preemptively adjust strategies, mitigating potential interference before it impacts network performance.

For example, at a venue such as a stadium equipped with state-of-the-art Wi-Fi and cellular networks, managing interference can be critical, especially during high-attendance events. A collaborative protocol can enable both network types (Wi-Fi and cellular) to exchange information on user density, location of hotspots, and signal quality in real-time. When a game day approaches, the protocol can adjust beamforming patterns to focus Wi-Fi signals in areas with high user concentration, such as the stands and concession areas, while cellular networks can reduce power in these areas to minimize crossover interference. Similarly, when the crowd moves, such as during half-time or post-game, the beamforming can dynamically shift to maintain optimal coverage and minimize interference.

Through the shared collaborative protocol, the system can anticipate when large volumes of people will simultaneously use their mobile devices, such as moments after a touchdown, and can preemptively adjust transmission power. Cellular networks might momentarily increase power to maintain service quality, while Wi-Fi networks can reduce transmission strength to avoid interference spikes.

Utilizing advanced analytics, the collaborative protocol can forecast potential interference issues by mapping network usage patterns against the event schedule. It can identify periods when interference is most likely to spike and can preemptively orchestrate a strategy across both network types to mitigate these risks. On game days, the stadium's network system can use historical data to predict when halftime will likely cause network strain. In anticipation, Wi-Fi networks can automatically adjust their channels, and cellular networks can temporarily deploy additional spectrum resources or implement traffic shaping measures to handle the surge.

Some implementations can integrate a mechanism to adapt game rules based on real-time environmental feedback, such as changes in network density, user demand, and spectrum efficiency metrics. This ensures the game remains relevant and effective under varying conditions, allowing for dynamic adjustments that reflect the current spectrum landscape.

To better rank operators for future use, a reputation system can be employed which can be based on networks' bidding behavior, efficiency in using allocated spectrum, and contribution to interference mitigation. A higher reputation can influence future allocations, encouraging networks to act in the best interest of the collective spectrum environment. Embodiments can also create economic incentives, such as spectrum sharing credits or financial benefits, for networks that engage in proactive sharing initiatives. For example, a network could earn credits for offering part of its allocated spectrum to others during low usage periods, which can be redeemed, e.g., for priority access in times of high demand.

In another embodiment, a dynamic pricing model can be applied for spectrum bids, in which the cost of spectrum allocations varies in real-time based on demand, supply, and network behavior. This approach encourages strategic bidding and ensures that spectrum resources are allocated to those who value them most at any given time.

Some implementations can also maintain a strategic reserve of spectrum that can be dynamically allocated during unexpected demand surges or to mitigate sudden interference issues. Access to this reserve can be managed through a separate, expedited bidding process, prioritizing networks with high efficiency and cooperation scores.

In an example dynamic spectrum allocation game, a value-based approach can be employed to quantify the spectrum allocation process, and the approach can optionally emphasize utility and performance optimizations rather than direct monetary costs. An example value-based approach can be implemented according to the below example model:

SV(NetworkType)=UB+(DF(NetworkType)×AF×BF(NetworkType)×CM)

Where SV (NetworkType) is a spectrum value, UB is a utility base which represents a baseline value of spectrum access, standardized for fair comparison across network types, DF is a demand factor adjusted for each type of network (Wi-Fi or Cellular), reflecting dynamic demand influenced by real-time analytics, AF is an availability factor which accounts for real-time availability of the spectrum, critical in environments with dense network deployments, BF is a behavior factor coefficient determined by historical and ongoing cooperative behavior in spectrum sharing, optimized through reinforcement learning algorithms, and CM is a context multiplier comprising a dynamic modifier calculated by context-aware algorithms that factor in variables such as user concentration in a stadium or network load due to a nearby event.

In an example application of the above model, in a large venue like a stadium in which network performance is optimized using a game-theoretic approach, an example UB can be defined as one hundred (100) spectrum points (SP), reflecting a base value of spectrum access for both Wi-Fi and Cellular networks in a high-demand environment such as a stadium during a major event. An example DF for Wi-Fi can be assigned a value of 1.8 as the stadium event begins, the stadium reaches full capacity, real-time attendance data indicates that the stadium is at 90% capacity, and fans are likely to share experiences on social media, contributing to a surge in Wi-Fi demand. An example AF can be set at to 0.3, for example, with a stadium event in progress, a high device count, a more competitive spectrum availability utilizing for example 70% of the spectrum and leaving a remaining 30% of available spectrum. An example BF can be 0.9, reflecting that based on the historical data, the Wi-Fi network has a strong record of efficient spectrum usage during past events. Conversely, if the cellular network has a lesser track record, it might have a BF of 1.1, reflecting the need for improvement. An example CM can be adjusted as the stadium event progresses. For example, during a first portion of the event, the CM may be at might be at 1.0, while during a second portion of the event with higher anticipated activity, the CM might Increase to 2.0 to accommodate the expected surge in network usage.

Using the above factors, the below hypothetical values can be calculated for spectrum allocation at a given time:

$$SV ( Wi - Fi ) = 100 SP + ( 100 SP \times 1.8 \times 0.3 \times 0.9 \times 1. )$$

$$SV ( Wi - Fi ) = 100 SP + 48.6 SP$$

$$SV ( Wi - Fi ) = 148.6 SP$$

$$SV ( Cellular ) = 100 SP + ( 100 SP \times 1.8 \times 0.3 \times 1.1 \times 1. )$$

$$SV ( Cellular ) = 100 SP + 59.4 SP$$

$$SV ( Cellular ) = 159.4 SP$$

The above calculated values are not static and will continuously adapt to the real-time conditions of the stadium environment. For example, if the stadium reaches full capacity, the DF may increase further. Likewise, if the spectrum utilization peaks beyond 70%, the AF will decrease, adjusting the SV accordingly. By continuously updating these values, the spectrum management controller can optimize allocation dynamically, ensuring network robustness and an optimal user experience.

In some examples, the disclosed SMC can implement an entity such as an AFC with advanced APIs. This model can coordinate spectrum allocation across multiple operators within a region, ensuring efficient spectrum utilization and maintaining quality of service. In parallel, the same framework can manage the spectrum locally at large venues, applying game-theoretic principles to optimize network performance for end-users.

Note that in the above example game-theoretic framework, the value is not represented by direct financial cost but by a scoring system that quantifies each network's right to access spectrum, ensuring an efficient and equitable distribution of spectrum. However, financial costs can also be employed, e.g., as a supplement to the scoring system.

In one aspect of this disclosure, a hybrid controller system can be employed which combines both on-premises and cloud-based controllers. A hybrid controller architecture can support decentralized decision-making, allowing for dynamic adjustments based on both local conditions and broader network trends. For instance, a local controller can handle immediate spectrum needs for an event such as a concert, while cloud-based controllers can optimize for larger-scale patterns like daily traffic flows. Using a distributed strategy enables local and central units to work together to adapt to both immediate and long-term challenges.

The disclosed game-theoretic mechanisms can also be used to support generating cross-technology spectrum sharing agreements, ensuring minimal interference and regulatory compliance. For example, automatic adjustments in transmission power and channel allocations can be made when detecting proximity between different network technologies, ensuring a cooperative stance between competing networks to manage shared resources effectively.

Leveraging game theory, adaptive strategies can be identified and applied to allocate spectrum based on the varying requirements of different network types (e.g., internet of things (IoT), high-speed internet, low-latency applications). For example, strategies can prioritize low-latency channels for emergency services during peak times, similar to allocating resources in a way that meets critical needs first while maintaining overall network performance.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

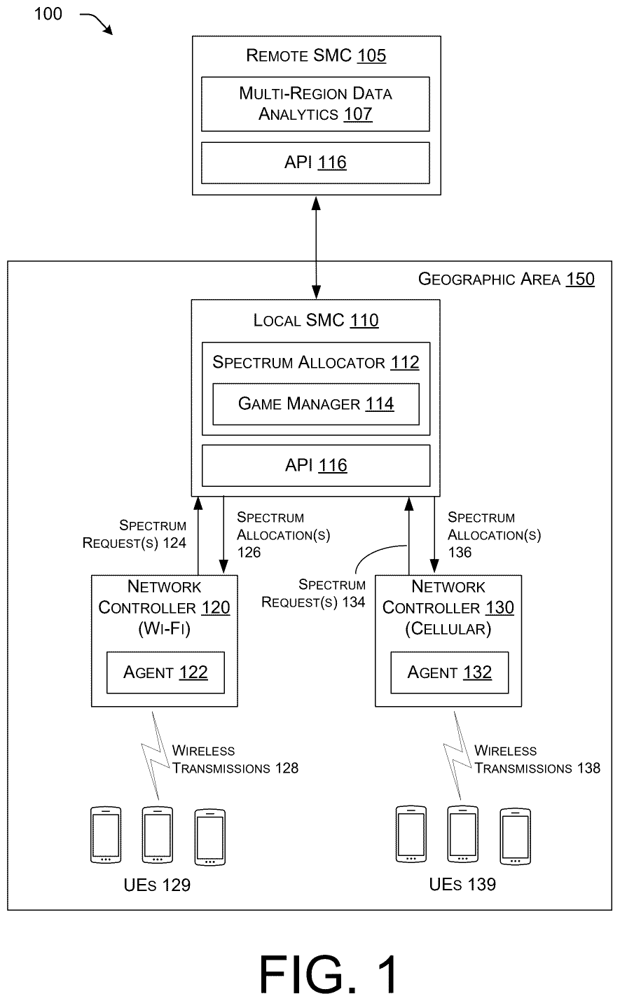

FIG. 1 illustrates an example architecture 100 comprising a remote spectrum management controller (SMC) 105, a local SMC 110, network controllers 120, 130, and user equipment (UEs) 129, 139, wherein spectrum used by the network controllers 120, 130 to communicate with the UEs 129, 139 is allocated by the local SMC 110 in cooperation with the remote SMC 105, in accordance with various aspects of the technologies disclosed herein.

In the illustrated example, the remote SMC 105 comprises multi-region data analytics 107 and an API 116. The local SMC 110 comprises a spectrum allocator 112 and the API 116. The spectrum allocator 112 includes a game manager 114. The network controller 120 is a Wi-Fi controller, e.g., a controller for a Wi-Fi local area network (LAN), and the network controller 120 comprises an agent 122 adapted to interact with the local SMC 110. The network controller 130 is a cellular controller, e.g., a controller for a fifth generation (5G) cellular network node, such as a gNodeB. The network controller 130 comprises an agent 132 adapted to interact with the local SMC 110.

The local SMC 110, the network controller 120, the network controller 130, and the UEs 129, 139 are all in a geographic area 150. Because the wireless transmissions 128, 138 are in the same geographic area 150, the wireless transmissions 128, 138 preferably use different spectrum allocations to avoid unwanted interference. The different spectrum allocations can be established at the local SMC 110, optionally in cooperation with the remote SMC 105, as described herein.

In example operations according to FIG. 1, the agents 122, 132 at the network controllers 120, 130 can be adapted to submit spectrum requests, also referred to herein as bids, to the local SMC 110. Network controller 120 can submit spectrum requests 124 via the API 116, and network controller 120 can submit spectrum requests 134 via the API 116. The local SMC 110, optionally in cooperation with the remote SMC 105, can be configured to determine spectrum allocations 126, 136 in response to the spectrum requests 124, 134, and the local SMC 110 can send the spectrum allocations 126, 136 to the network controllers 120, 130 via the API 116. The network controllers 120, 130 can be configured to use the spectrum allocated to them via the spectrum allocations 126, 136 for wireless transmissions 128, 138 involving the UEs 129, 139.

In some embodiments, the geographical area 150 can comprise a building such as an airport, stadium, conference center, school, or commercial building. The local SMC 110, the network controllers 120, 130, and the UEs 129, 139 can be positioned in the building. In other embodiments, the geographical area 150 can be defined as an area having a defined shape and size. The techniques described herein are useful to avoid interference between wireless transmissions 128 and wireless transmissions 138, and so can be applied even when one or more of the local SMC 110, the network controllers 120, 130, and the UEs 129, 139 are outside the geographic area 150, so long as wireless transmissions 128 and wireless transmissions 138 present a risk of interference.

The spectrum request(s) 124, 134 can be sent by the network controllers 120, 130 multiple times in accordance with a multi-round bidding process. At each round, the local SMC 110 can return spectrum allocation(s) 126, 136, and the spectrum allocation(s) 126, 136 can change dynamically between rounds.

Depending on the implementation, the spectrum request(s) 124, 134 can optionally comprise bids which specify some value, whether financial or credits, or the spectrum request(s) 124, 134 can comprise no explicit specified value. When the spectrum request(s) 124, 134 do not comprise a specified value, the local SMC 110 can nonetheless assign values to the spectrum request(s) 124, 134. For example, the assigned values may be based on historic spectrum use efficiencies of different respective controllers 120, 130. When the spectrum request(s) 124, 134 do comprise specified values, the local SMC 110 can adjust the specified values based on any number of factors, including but not limited to the historic spectrum use efficiencies of different respective controllers 120, 130.

The local SMC 110 can apply the spectrum allocator 112 to determine spectrum allocations 126, 136 in response to the spectrum request(s) 124, 134. The spectrum allocator 112 can assign or modify values of the spectrum request(s) 124, 134, as discussed herein, and the spectrum allocator 112 can use the game manager 114 to process the resulting values according to a spectrum allocation game. The spectrum allocation game can result in a combined output that includes spectrum allocations 126, 136 for all of the players, i.e., for all of the network controllers 120, 130 that submitted spectrum request(s) 124, 134.

The spectrum allocator 112 can use any of a wide variety of data in connection with determining values to associate with the spectrum request(s) 124, 134. For example, in some embodiments, the spectrum allocator 112 can receive and use network data for use in connection with the formula disclosed above:

$$SV ( NetworkType ) = UB + ( DF ( NetworkType ) \times AF \times BF ( NetworkType ) \times CM )$$

More generally, the spectrum allocator 112 can establish or adjust values based on, e.g., respective historic spectrum use efficiencies of respective network controllers 120, 130. The network controllers 120, 130 can be configured to report historic spectrum use efficiency information to the network controllers 120, 130, which can be used by the network controllers 120, 130 to establish bid values.

In another example, the spectrum allocator 112 can establish or adjust values based on, e.g., respective bid information included in the spectrum request(s) 124, 134. The network controllers 120, 130 can be configured to submit bid values of money or credits that the network controllers 120, 130 are prepared to expend in exchange for spectrum allocation, and the spectrum allocator 112 can use the bid values, optionally along with other information, to adjust values of the spectrum request(s) 124, 134.

In another example, the spectrum allocator 112 can establish or adjust values based on, e.g., a spectrum allocation input from the remote SMC 105. The remote SMC 105 can be configured to use multi-region data analytics 107 to calculate a spectrum allocation input to provide to the local SMC 110. The remote SMC 105 can also optionally supply the same or different spectrum allocation inputs to other local SMCs. The spectrum allocation input can comprise, e.g., guidance regarding spectrum allocations, or spectrum allocation rules, which can be followed by the local SMC 110 when assigning values to the spectrum request(s) 124, 134. For example, the spectrum allocation input can provide user equipment movement analytics information such as device roaming information for further processing by the local SMC 110, or the spectrum allocation input can specify a range of spectrum which is preferably devoted to a Wi-Fi or cellular network type, or the spectrum allocation input can specify a range or weights to apply to particular network providers/operators.

In another example, the spectrum allocator 112 can establish or adjust values based on, e.g., network condition information such congestion indicators and signal quality indicators applicable to the wireless transmissions 128, 138. The network controllers 120, 130 can be configured to report network condition information as measured at the network controllers 120, 130 and the spectrum allocator 112 can use the network condition information, optionally along with other information, to adjust values of the spectrum request(s) 124, 134.

In another example, the spectrum allocator 112 can establish or adjust values based on, e.g., cooperation parameters for the multiple network controllers 120, 130. The network controllers 120, 130 can be configured to cooperate for example by sharing data with a cooperation module at the local SMC 110, and the extent of the network controllers 120, 130 engagements can be measured and stored as cooperation parameters. The shared data can include, e.g., network measurement data such as congestion or signal quality, spectrum use efficiency information, interference mitigation information, or any other requested info which can be used to improve overall combined spectrum allocation efficiency. The spectrum allocator 112 can use the cooperation parameters, optionally along with other information, to adjust values of the spectrum request(s) 124, 134.

Any of the above described data which can be used in connection with determining values to associate with the spectrum request(s) 124, 134, as described above, can alternatively be applied to spectrum allocations 126, 136 after the game manager 114 processes the values according to the spectrum allocation game. Some examples can base the spectrum allocation game on adjusted value information, which is adjusted according to one or more first data inputs, and can then apply one or more second data inputs to adjust spectrum allocation outputs of the spectrum allocation game.

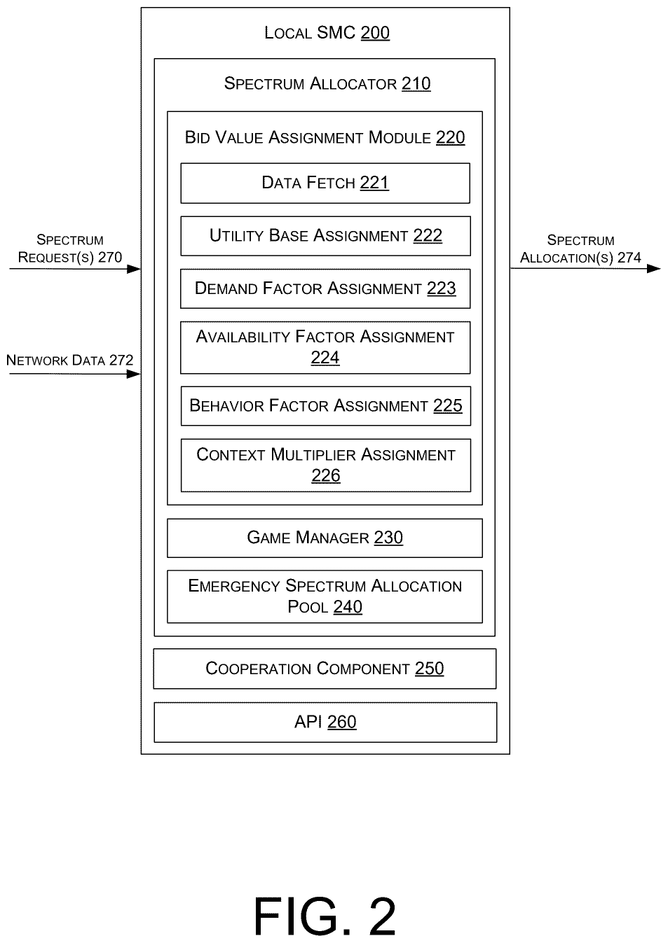

Furthermore, as described further in connection with FIG. 2, in some embodiments the spectrum allocator 112 can be configured to reserve an emergency spectrum allocation pool, which is not allocated according to the normal operation of the game manager 114. Instead, the emergency spectrum allocation pool can be allocated under conditions that satisfy an emergency use definition, e.g., a humanitarian emergency such as a fire or extreme weather, or a network emergency such as an outage of certain networks or atypically high congestion. More generally, the spectrum allocator 112 need not always apply the game manager 114 to allocate spectrum. Some network conditions, such as very low traffic conditions, may warrant switching modes so that, e.g., any network controller 130 can be granted any requested spectrum, or spectrum allocations are done on a first come first served or equal allocation basis.

FIG. 2 illustrates an example local SMC 200 and example components thereof, in accordance with various aspects of the technologies disclosed herein. The local SMC 200 can implement the local SMC 110 introduced in FIG. 1 in some embodiments. The local SMC 200 includes a spectrum allocator 210, a cooperation component 250, and an API 260. The spectrum allocator 210 comprises a bid value assignment module 220, a game manager 230, and an emergency spectrum allocation pool 240. The bid value assignment module 220 comprises data fetch 221, utility base assignment 222, demand factor assignment 223, availability factor assignment 224, behavior factor assignment 225, and context multiplier assignment 226.

In an example according to FIG. 2, the local SMC 200 can receive spectrum request(s) 270 from network controllers, such as the network controllers 120, 130 illustrated in FIG. 1. The local SMC 200 can use the spectrum allocator 210 to allocate spectrum to the requesting network controllers. The spectrum allocator 210 may request or otherwise receive a variety of data, referred to in FIG. 2 as network data 272, for use in connection with determining spectrum allocations. Spectrum allocations determined by the spectrum allocator 210 can be returned to the network controllers as spectrum allocation(s) 274.

The bid value assignment module 220 can use any of a variety of different data to assign values to spectrum request(s) 270, as discussed in connection with FIG. 1. In the illustrated embodiment, the bid value assignment module 220 is configured to assign values using the spectrum value assignment formula set forth herein. Data fetch 221 can be configured to fetch or otherwise receive network data 272 used by the other components of the bid value assignment module 220.

For example, utility base assignment 222 can be configured to use data fetch 221 to retrieve network data 272 as needed to assign a utility base. Demand factor assignment 223 can be configured to use data fetch 221 to retrieve network data 272 as needed to assign a demand factor. Availability factor assignment 224 can be configured to use data fetch 221 to retrieve network data 272 as needed to assign an availability factor. Behavior factor assignment 225 can be configured to use data fetch 221 to retrieve network data 272 as needed to assign a behavior factor. Context multiplier assignment 226 can be configured to use data fetch 221 to retrieve network data 272 as needed to assign a context multiplier. Data fetch 221 can optionally retrieve and store data from the network controllers, a remote SMC, or other data sources.

Once the utility base assignment 222, demand factor assignment 223, availability factor assignment 224, behavior factor assignment 225, and context multiplier assignment 226 have assigned their respective factor values, for each of the spectrum request(s) 270, the bid value assignment module 220 can combine the respective factor values into respective bid values corresponding to each of the spectrum request(s) 270. The values can then be processed by the game manager 230 to determine spectrum allocation(s) 274. For example, the game manager 230 may determine a Nash equilibrium which optimizes combined spectrum use efficiency across all network controllers. The game rules applied by game manager 230 can optionally be dynamically adjusted to encourage different behaviors in response to different network conditions.

If emergency conditions are met, then the spectrum allocator 210 can use spectrum from the emergency spectrum allocation pool 240 for the spectrum allocation(s) 274. The spectrum from the emergency spectrum allocation pool 240 can be used for some or all of the spectrum allocation(s) 274.

The cooperation component 250 can optionally be configured to communicate with network controllers to retrieve and store cooperation data. Example cooperation data can comprise, e.g., interference mitigation data, spectrum use efficiency data, network condition data, etc. Behavior factor assignment 225 can optionally assign cooperation parameters based on a network controller's level of engagement with the cooperation component 250.

The API 260 can comprise an interface to network controllers as well as to a remote SMC. The spectrum requests 270, network data 272, spectrum allocations 274, and any further data such as cooperation data can optionally transmitted via the API 260.

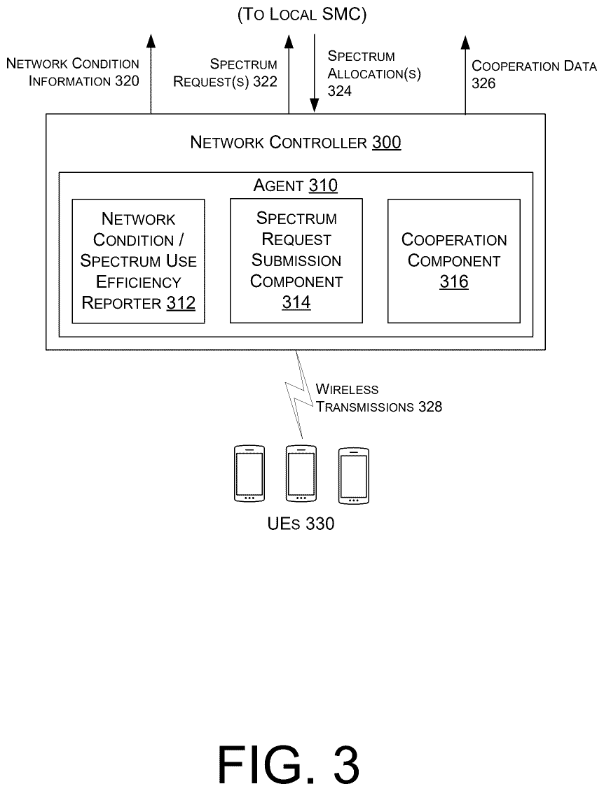

FIG. 3 illustrates an example network controller 300 comprising an agent 310 adapted to interact with a local SMC, in accordance with various aspects of the technologies disclosed herein. The network controller 300 and agent 310 can implement either of the network controllers 120, 130 and agents 122, 132 introduced in FIG. 1 in some embodiments. The illustrated example agent 310 comprises a network condition/spectrum use efficiency reporter 312, a spectrum request submission component 314, and a cooperation component 316.

In an example according to FIG. 3, the network condition/spectrum use efficiency reporter 312 can report network condition information 320, such as congestion measurements and signal quality measurements, to the local SMC. The cooperation component 316 can report cooperation data 326, such as additional network condition information and/or interference mitigation strategy information, to the local SMC. The network condition/spectrum use efficiency reporter 312 and cooperation component 316 can communicate with the local SMC either by responding to local SMC data requests, or by reporting information on a reporting interval or as-available basis.

The spectrum request submission component 314 can be configured to submit spectrum request(s) 322 to the local SMC. The spectrum request(s) 322 can optionally include bid value information, spectrum use efficiency information, or any other information specified for spectrum request(s) 322. The spectrum request(s) 322 can also be submitted according to a timing specified by the local SMC. For example, in order to participate in a multi-round bidding process, the spectrum request submission component 314 can send first spectrum request(s) 322 on or before a first round deadline specified by the local SMC and can send second spectrum request(s) 322 on or before a second round deadline specified by the local SMC, and so on for subsequent bidding rounds. In some embodiments, the network controller 300 and agent 310 can be configured to activate the spectrum request submission component 314 when the network controller 300 projects a need for additional spectrum, and the spectrum request submission component 314 need not be activated when additional spectrum is not needed.

The network controller 300 can be configured to receive spectrum allocation(s) 324 in response to the spectrum request(s) 322. The spectrum allocation(s) 324 can be associated with different expiration times, and the network controller 300 can use spectrum within the spectrum allocation(s) 324 for wireless transmissions 328 to the UEs 330, until the spectrum allocation(s) 324. If the network controller 300 projects a need for spectrum beyond an expiration of the spectrum allocation(s) 324, the spectrum request submission component 314 can be activated to submit additional spectrum request(s) 322.

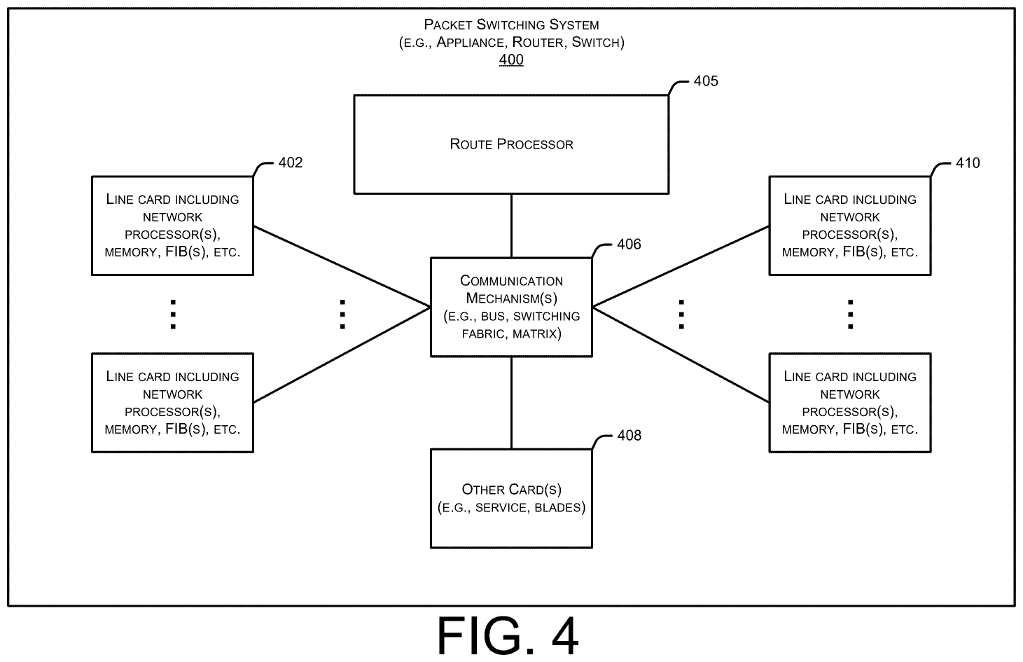

FIG. 4 illustrates an example packet switching system 400 that can be utilized to implement devices such as routers or other access point devices, which can implement network controllers in accordance with various aspects of the technologies disclosed herein. In some examples, the packet switching system 400 can be implemented as one or more packet switching device(s). The packet switching system 400 may be employed in a network, for example, the packet switching system 400 can implement a router configured to process network traffic by receiving and forwarding packets.

In some examples, the packet switching system 400 may comprise multiple line card(s) 402, 410, each with one or more network interfaces for sending and receiving packets over communications links (e.g., possibly part of a link aggregation group). The packet switching system 400 may also have a control plane with one or more processing elements, e.g., the route processor 405 for managing the control plane and/or control plane processing of packets associated with forwarding of packets in a network. The packet switching system 400 may also include other cards 408 (e.g., service cards, blades) which include processing elements that are used to process (e.g., forward/send, drop, manipulate, change, modify, receive, create, duplicate, apply a service) packets associated with forwarding of packets in a network.

The packet switching system 400 may comprise a communication mechanism 406 (e.g., bus, switching fabric, and/or matrix, etc.) for allowing the different entities such as the multiple line card(s) 402, 410, the route processor 405, and the other cards 408 to communicate. The communication mechanism 406 can optionally be hardware-based. Line card(s) 402, 410 may perform the actions of being both an ingress and/or an egress line card of the line card(s) 402, 410, with regard to multiple packets and/or packet streams being received by, or sent from, the packet switching system 400.

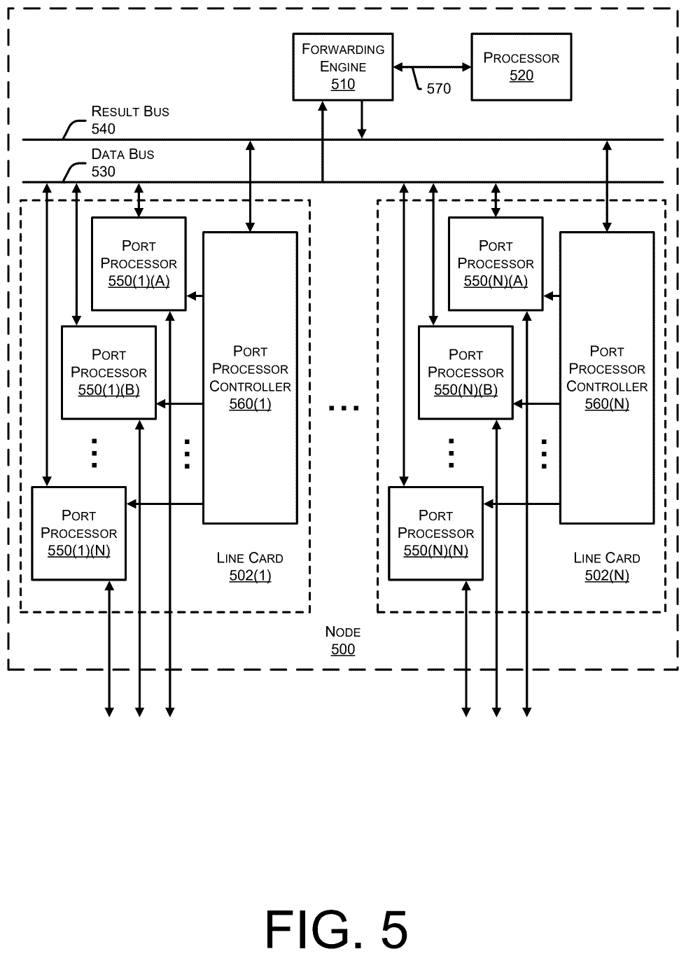

FIG. 5 illustrates an example node that can be utilized to implement devices in accordance with various aspects of the technologies disclosed herein. For example, the node 500 can implement any of the network controllers described herein. In some examples, node 500 may include any number of line cards 502, e.g., line cards 502(1)-(N), where N may be any integer greater than 1, and wherein the line cards 502 are communicatively coupled to a forwarding engine 510 (also referred to herein as an encryption engine) and/or a processor 520 via a data bus 530 and/or a result bus 540.

Line cards 502 may include any number of port processors 550, for example, line card 502(1) comprises port processors 550(1)(A)-550(1)(N), and line card 502(N) comprises port processors 550(N)(A)-550(N)(N). The port processors 550 can be controlled by port processor controllers 560, e.g., port processor controllers 560(1), 560(N), respectively.

Additionally, or alternatively, the forwarding engine 510 and/or the processor 520 can be coupled to one another via the data bus 530 and the result bus 540 and may also be communicatively coupled to one another by a communications link 570. The processors (e.g., the port processor(s) 550 and/or the port processor controller(s) 560) of each line card 502 may optionally be mounted on a single printed circuit board.

When a packet or packet and header are received, the packet or packet and header may be identified and analyzed by the node 500 in the following manner. Upon receipt, a packet (or some or all of its control information) or packet and header may be sent from one of port processor(s) 550 at which the packet or packet and header was received and to one or more of those devices coupled to the data bus 530 (e.g., others of the port processor(s) 550, the forwarding engine 510 and/or the processor 520). Handling of the packet or packet and header may be determined, for example, by the forwarding engine 510.

For example, the forwarding engine 510 may determine that the packet or packet and header should be forwarded to one or more of the other port processors 550. This may be accomplished by indicating to corresponding one(s) of port processor controllers 560 that a copy of the packet or packet and header held in the given one(s) of port processor(s) 550 should be forwarded to the appropriate other one of port processor(s) 550. Additionally, or alternatively, once a packet or packet and header has been identified for processing, the forwarding engine 510, the processor 520, and/or the like may be used to process the packet or packet and header in some manner and/or may add packet security information in order to secure the packet.

On a node 500 sourcing a packet or packet and header, processing may include, for example, encryption of some or all of the packet or packet and header information, the addition of a digital signature, and/or some other information and/or processing capable of securing the packet or packet and header. On a node 500 receiving a packet or packet and header, the processing may be performed to recover or validate the packet or packet and header information that has been secured.

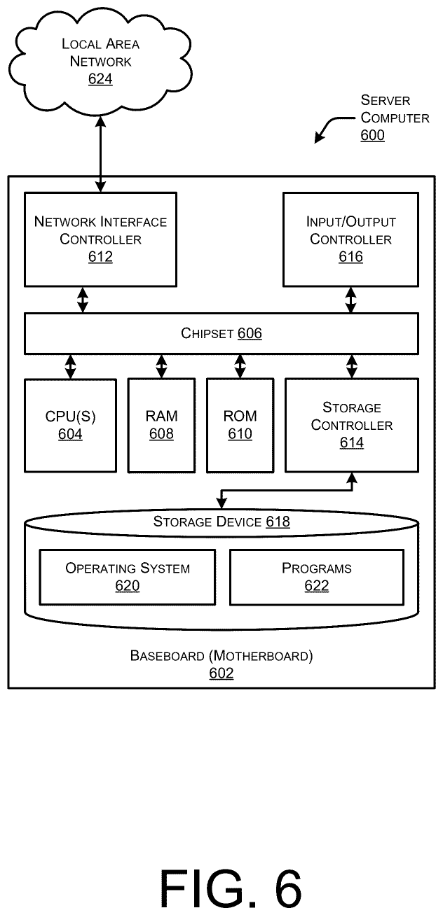

FIG. 6 illustrates an example computer hardware architecture that can implement devices in accordance with various aspects of the technologies disclosed herein. For example, the illustrated computer hardware architecture can implement devices hosting local and/or remote SMCs, in some embodiments. The computer architecture shown in FIG. 6 illustrates a conventional server computer 600, however the computer architecture can optionally implement any other computing devices such as a router, a workstation, desktop computer, laptop, tablet, network appliance, e-reader, smartphone, or other computing device. The illustrated computer architecture can be utilized to execute any of the software components presented herein.

The server computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the server computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the server computer 600. The chipset 606 can further provide an interface to a computer-readable storage medium such as a read-only memory (“ROM”) 610 or non-volatile RAM (“NVRAM”) for storing basic routines that help to start up the server computer 600 and to transfer information between the various components and devices. The ROM 610 or NVRAM can also store other software components necessary for the operation of the server computer 600 in accordance with the configurations described herein.

The server computer 600 can operate in a networked environment using logical connections to remote computing devices and computer systems through a network, such as the LAN 624. The chipset 606 can include functionality for providing network connectivity through a NIC 612, such as a gigabit Ethernet adapter. The NIC 612 is capable of connecting the server computer 600 to other computing devices over the LAN 624. It should be appreciated that multiple NICs 612 can be present in the server computer 600, connecting the computer to other types of networks and remote computer systems.

The server computer 600 can be connected to a storage device 618 that provides non-volatile storage for the server computer 600. The storage device 618 can store an operating system 620, programs 622, and data, to implement any of the various components described in detail herein.

The storage device 618 can be connected to the server computer 600 through a storage controller 614 connected to the chipset 606. The storage device 618 can comprise one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the server computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 600 can further read information from the storage device 618 by detecting the physical states or characteristics of one or more particular locations within the physical storage units.

In addition to the mass storage device 618 described above, the server computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 600. In some examples, the operations performed by the computing elements illustrated in FIGS. 1-3, FIG. 7, and or any components included therein, may be supported by one or more devices similar to server computer 600.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the server computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the server computer 600.

In one embodiment, the storage device 618 or other computer-readable storage media is encoded with computer-executable instructions which, when loaded into the server computer 600, transform the computer from a general-purpose computing system into a special-purpose computer capable of implementing the embodiments described herein. These computer-executable instructions transform the server computer 600 by specifying how the CPUs 604 transition between states, as described above.

According to one embodiment, the server computer 600 has access to computer-readable storage media storing computer-executable instructions which, when executed by the server computer 600, can implement the architectures and perform the various processes described with regard to FIGS. 1-3 and FIG. 7. The server computer 600 can also include computer-readable storage media having instructions stored thereupon for performing any of the other computer-implemented operations described herein.

The server computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat panel display, a digital projector, a printer, or other type of output device. It will be appreciated that the server computer 600 might not include all of the components shown in FIG. 6, can include other components that are not explicitly shown in FIG. 6, or might utilize an architecture completely different than that shown in FIG. 6.

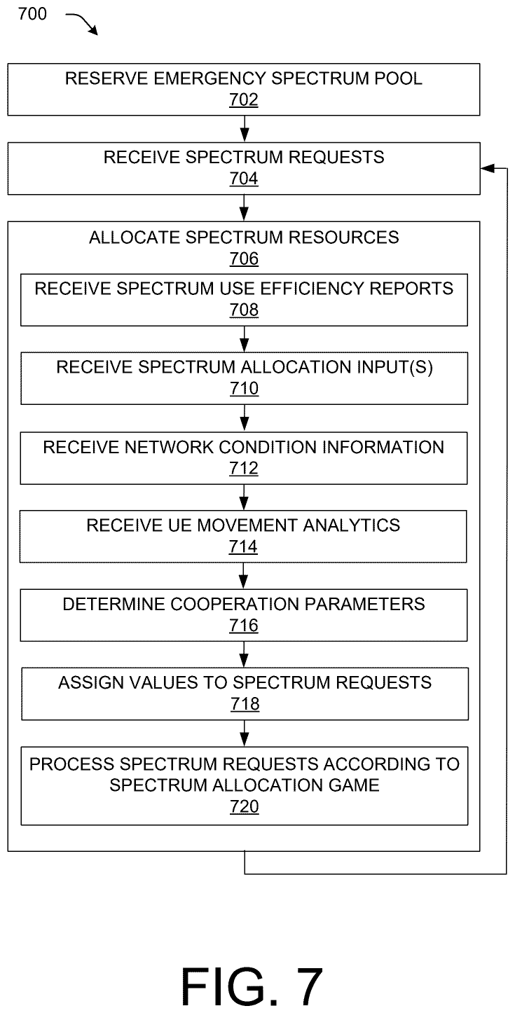

FIG. 7 is a flow diagram of an example method 700 performed at least partly by a computing device, such as the server computer 600, optionally in conjunction with other computing devices. The logical operations described herein with respect to FIG. 7 may be implemented (1) as a sequence of computer-implemented acts or program modules running on a computing system and/or (2) as interconnected machine logic circuits or circuit modules within the computing system. In some examples, the method 700 may be performed by a system comprising one or more processors and one or more non-transitory computer-readable media storing computer-executable instructions that, when executed by the one or more processors, cause the one or more processors to perform the method 700.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof.

It should also be appreciated that more or fewer operations might be performed than shown in FIG. 7 and described herein. These operations can also be performed in parallel, or in a different order than those described herein. Some or all of these operations can also be performed by components other than those specifically identified. Although the techniques described in this disclosure are with reference to specific components, in other examples, the techniques may be implemented by fewer components, more components, different components, or any configuration of components.

FIG. 7 is a flow diagram that illustrates an example method for a local SMC to allocate spectrum based at least in part on a spectrum allocation game, in accordance with various aspects of the technologies disclosed herein. In an example embodiment, the illustrated method can be performed by a local SMC such as the local SMC 110, introduced in FIG. 1.

At operation 702, the local SMC 110 can reserve an emergency spectrum allocation pool, such as the emergency spectrum allocation pool 240. The emergency spectrum allocation pool 240 can generally be reserved during normal operations of the spectrum allocator 112, so that multiple spectrum allocations made by the spectrum allocator 112 do not include allocations from the emergency spectrum allocation pool 240.

At operation 704, the local SMC 110, which is associated with a geographic area 150, can receive via an API 116 multiple spectrum requests 124, 134 from multiple network controllers 120, 130 adapted to transmit and receive wireless transmissions 128, 138 in the geographic area 150. The multiple network controllers 120, 130 can include at least one Wi-Fi local area network (LAN) controller, such as network controller 120, and at least one cellular access network controller, such as network controller 130. The multiple spectrum requests 124, 134 can optionally include bid value information, and the bid value information can be part of the information upon which multiple spectrum allocations 126, 136 are based.

At operation 706, the local SMC 110 can allocate spectrum resources among the multiple network controllers 120, 130. Operation 706 can comprise operations 708-720. At operation 708, the local SMC 110 can receive respective historic spectrum use efficiency reports from respective network controllers 120, 130. At operation 710, the local SMC 110 can receive a spectrum allocation input from a remote SMC 105. At operation 712, the local SMC 110 can receive network condition information comprising, e.g., at least one congestion indicator and at least one signal quality indicator, from network controllers 120, 130. At operation 714, the local SMC 110 can receive UEs 129, 139 movement analytics information, e.g., from the remote SMC 105. At operation 716, the local SMC 110 can determine cooperation parameters for the multiple network controllers 120, 130. The cooperation parameters can optionally be based at least in part on sharing, by the multiple network controllers 120, 130, interference mitigation information.

The local SMC 110 can allocate spectrum resources among the multiple network controllers 120, 130 based on any of the information received at operations 708-716. In some embodiments, at operation 718 the local SMC 110 can assign a respective value to each respective spectrum request of the spectrum request(s) 124, 134, wherein the respective values are adjusted based on the information received at operations 708-716, namely the historic spectrum use efficiencies, spectrum allocation inputs, network condition information, UE movement analytics information, and/or cooperation parameters received at operations 708-716.

At operation 720, the game manager 114 can process the multiple spectrum requests 124, 134 according to a spectrum allocation game which uses respective values assigned to the multiple spectrum requests 124, 134 to determine multiple spectrum allocations 126, 136 to the multiple network controllers 120, 130. In one example, the multiple spectrum allocations 126, 136 can comprise an optimal combined spectrum use efficiency. In another example, the multiple spectrum allocations 126, 136 can comprise a first combined spectrum use efficiency which is higher than at least one second combined spectrum use efficiency resulting from different spectrum allocations to the multiple network controllers 120, 130, e.g., a second combined spectrum use which does not apply the spectrum allocation game.

An arrow from operation 706 returning to operation 704 signifies that the illustrated method can optionally be repeated, e.g., in multiple bidding rounds, to determine different subsequent sets of multiple spectrum allocations 126, 136 to the multiple network controllers 120, 130.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
receiving, at a local spectrum management controller associated with a geographic area, via an application programming interface (API) at the local spectrum management controller, multiple spectrum requests from multiple network controllers adapted to transmit and receive wireless signals in the geographic area,
wherein the multiple network controllers include at least one wireless fidelity (Wi-Fi) local area network (LAN) controller and at least one cellular access network controller;
allocating, by the local spectrum management controller, spectrum resources among the multiple network controllers, wherein allocating the spectrum resources comprises:
assigning a respective value to each respective spectrum request, wherein the respective value is adjusted based on a respective historic spectrum use efficiency of a respective network controller; and
processing the multiple spectrum requests according to a spectrum allocation game which uses respective values assigned to the multiple spectrum requests to determine multiple spectrum allocations to the multiple network controllers,
wherein the multiple spectrum allocations comprise a first combined spectrum use efficiency which is higher than at least one second combined spectrum use efficiency resulting from different spectrum allocations to the multiple network controllers.

2. The method of claim 1, further comprising receiving, at the local spectrum management controller, a spectrum allocation input from a remote spectrum management controller, and wherein the multiple spectrum allocations are based in part on the spectrum allocation input.

3. The method of claim 1, further comprising receiving, at the local spectrum management controller, network condition information comprising at least one congestion indicator and at least one signal quality indicator, and wherein the multiple spectrum allocations are based in part on the network condition information.

4. The method of claim 1, further comprising receiving, at the local spectrum management controller, user equipment movement analytics information, and wherein the multiple spectrum allocations are based in part on the user equipment movement analytics information.

5. The method of claim 1, further comprising determining, by the local spectrum management controller, cooperation parameters for the multiple network controllers, wherein the multiple spectrum allocations are based in part on the cooperation parameters.

6. The method of claim 5, wherein the cooperation parameters are based on sharing, by the multiple network controllers, interference mitigation information.

7. The method of claim 1, further comprising reserving, by the local spectrum management controller, an emergency spectrum allocation pool, wherein the multiple spectrum allocations do not include allocations from the emergency spectrum allocation pool.

8. The method of claim 1, further comprising repeating the method to determine a different set of multiple spectrum allocations to the multiple network controllers.

9. The method of claim 1, wherein the multiple spectrum requests include bid value information, and wherein the multiple spectrum allocations are based in part on the bid value information.

10. A device comprising:
one or more processors; and
one or more non-transitory computer-readable media storing computer-executable instructions that, when executed by the one or more processors, cause the one or more processors to perform operations comprising:
receiving, at a local spectrum management controller associated with a geographic area, via an application programming interface (API) at the local spectrum management controller, multiple spectrum requests from multiple network controllers adapted to transmit and receive wireless signals in the geographic area,
wherein the multiple network controllers include at least one wireless fidelity (Wi-Fi) local area network (LAN) controller and at least one cellular access network controller;
allocating, by the local spectrum management controller, spectrum resources among the multiple network controllers, wherein allocating the spectrum resources comprises:
assigning a respective value to each respective spectrum request, wherein the respective value is adjusted based on a respective historic spectrum use efficiency of a respective network controller; and
processing the multiple spectrum requests according to a spectrum allocation game which uses respective values assigned to the multiple spectrum requests to determine multiple spectrum allocations to the multiple network controllers,
wherein the multiple spectrum allocations comprise a first combined spectrum use efficiency which is higher than at least one second combined spectrum use efficiency resulting from different spectrum allocations to the multiple network controllers.

11. The device of claim 10, wherein the operations further comprise receiving, at the local spectrum management controller, a spectrum allocation input from a remote spectrum management controller, and wherein the multiple spectrum allocations are based in part on the spectrum allocation input.

12. The device of claim 10, wherein the operations further comprise receiving, at the local spectrum management controller, network condition information comprising at least one congestion indicator and at least one signal quality indicator, and wherein the multiple spectrum allocations are based in part on the network condition information.

13. The device of claim 10, wherein the operations further comprise receiving, at the local spectrum management controller, user equipment movement analytics information, and wherein the multiple spectrum allocations are based in part on the user equipment movement analytics information.

14. The device of claim 10, wherein the operations further comprise determining, by the local spectrum management controller, cooperation parameters for the multiple network controllers, wherein the multiple spectrum allocations are based in part on the cooperation parameters.

15. The device of claim 14, wherein the cooperation parameters are based on sharing, by the multiple network controllers, interference mitigation information.

16. The device of claim 10, wherein the operations further comprise reserving, by the local spectrum management controller, an emergency spectrum allocation pool, wherein the multiple spectrum allocations do not include allocations from the emergency spectrum allocation pool.

17. The device of claim 10, wherein the operations are repeated to determine a different set of multiple spectrum allocations to the multiple network controllers.

18. The device of claim 10, wherein the multiple spectrum requests include bid value information, and wherein the multiple spectrum allocations are based in part on the bid value information.

19. A method comprising:
receiving, at a spectrum management controller, multiple spectrum requests from each of multiple network controllers adapted to transmit and receive wireless signals, wherein each of the multiple spectrum requests comprises respective bid value information;
wherein the multiple network controllers include at least one wireless fidelity (Wi-Fi) local area network (LAN) controller and at least one cellular access network controller;
allocating, by the spectrum management controller, spectrum resources among the multiple network controllers, wherein allocating the spectrum resources comprises:
assigning a respective value to each respective spectrum request, wherein the respective value is adjusted based on a respective historic spectrum use efficiency of a respective network controller and the bid value information; and
processing the multiple spectrum requests according to a spectrum allocation game which uses respective values assigned to the multiple spectrum requests to determine multiple spectrum allocations to the multiple network controllers,
wherein the multiple spectrum allocations comprise a first combined spectrum use efficiency which is higher than at least one second combined spectrum use efficiency resulting from different spectrum allocations to the multiple network controllers.

20. The method of claim 19, further comprising determining, by the spectrum management controller, cooperation parameters for the multiple network controllers, wherein the multiple spectrum allocations are based in part on the cooperation parameters.
